(19) United States
(12) Patent Application Publication
(10) Pub. No.: US 2019/0232762 A1
(43) Pub. Date: Aug. 1, 2019

(54) MULTI-DIMENSIONALLY-ADJUSTABLE, POINT-SOURCE, SUN SHADE APPARATUS AND METHOD

(71) Applicant: Tim Wilson, Huntsville, UT (US)

(72) Inventor: Tim Wilson, Huntsville, UT (US)

(21) Appl. No.: 16/261,169

(22) Filed: Jan. 29, 2019

Related U.S. Application Data
(60) Provisional application No. 62/623,953, filed on Jan. 30, 2018.

(51) Int. Cl. B60J 3/02

(52) U.S. Cl. CPC B60J 3/0208; B60J 3/0278; B60J 3/0217

(57) ABSTRACT

An apparatus as a blind or blocker (miniature sun visor) selectively attaches to any edge of a standard visor equipped in a vehicle, whether the visor is stowed (undeployed, non-deployed), or positioned for use (deployed). A clamp selectively grips the visor, a panel blocks (subtends the angle made by two eyes and the point source) the light from a point source, and a flexible, self-stabilizing, extension (or adjuster) extends between the clamp and panel. The extension is sufficiently long to reach well beyond the visor to “cover” (occlude) a point source of light, such as the sun or a reflected beam, from both eyes of a user. A gooseneck extension between the clamp and panel can straighten, bend, twist, turn or otherwise re-shape inelastically to support a position of the panel moved by a single hand.

### RELATED APPLICATIONS

This application claims the benefit of U.S. Provisional Patent Application Ser. No. 62/623,953, filed Jan. 30, 2018, which is hereby incorporated by referenced in its entirety.

### BACKGROUND

### 1. Field of the Invention

This invention relates to vehicles and, more particularly, to novel systems and methods for sun shades and visors for improving visibility for drivers.

### 2. Background Art

Vehicles have existed for millennia from chariots and ox carts having only two wheels, to four wheel vehicles with steering, to self-propelled automobiles in all their varieties. From the smallest cars to the largest trucks, vehicles have developed rapidly in recent centuries. Protecting drivers from objects, sun, cold, rain, and other weather, and undesirable conditions has served as motivation for the development of many accessories.

One of those accessories is the sun visor. Sun visors are typically mounted pivotably to one side of a vehicle, near the windshield. Typically, they include a rod operating as an axle or pivot in order to permit a user to pivot a visor panel upward toward the ceiling of the vehicle, and away from the windshield. Pivoting in the opposite direction, downward, a visor may be positioned to occlude a large portion of the driver's field of view. For example, a bright sky may be occluded by the presence of a sun visor blocking an upper portion of a windshield such that the driver may only see objects below the level of the visor.

Some visors may also pivot about a vertical axis to provide blockage of light coming through a side window. Modern visors have effectively taken on a standard configuration of a mount securing a rod having a comparatively short, vertical portion that is bent to turn into a comparatively long, horizontal axle. About that long portion acting as an axle, the visor is secured to pivot up and down, defining a horizontal axis. Meanwhile, the mounting system to the vehicle typically permits the vertical part of the rod to pivot between a front windshield position and a side window position. Visors exist for a driver's side as well as a passenger's side of a vehicle cab.

For their virtues, visors necessarily have their limitations. Most vehicles have a rear view mirror. Visors typically are not easily configured to block light in the area of the rearview mirror. The length of visors horizontally cannot block a mirror to extend to every area where the blockage of light may be needed.

Also, for example, side windows are often not protected by a visor if a seat has been positioned comparatively farther away from the steering wheel rather than comparatively closer to the steering wheel. Moreover, visors occlude a large fraction of a windshield.

Thus, it would be an advance in the art to provide a small shade or visor that may be used in conjunction with, or instead of, a conventional, built-in, sun visor of a vehicle. It would be another advance in the art to provide three-dimensional adjustability of that visor. It would also be an advance to provide a panel for the visor that is comparatively much smaller than a vehicle visor, thus occluding less of a driver's field of view. It would be a further advance in the art, to provide a small shade or visor that is easily adjustable with a single hand, to any desired position.

It would be a further advance to provide a shade or visor that is effective to block out light from bright, point sources, such as the sun, occupying a comparatively constant location in a driver's field of view on a long drive. For example, traveling down a highway in a single direction for many miles may place the sun directly in an awkward position, glaring into the eyes of a user (driver), and not reachable by the vehicle's visor. That is, the visor does not extend to block the line of sight between the eyes of a user and the point source, the sun. Moreover, it would be an advance to provide the option to a driver to either use a large visor inherent in a vehicle, for blocking out general sky light, as intended, while providing an additional or substitute visor that effectively occludes only a comparatively small area between the eyes of a user and a distant point source, such as the sun or a reflecting object.

### BRIEF SUMMARY OF THE INVENTION

In view of the foregoing, in accordance with the invention as embodied and broadly described herein, a method and apparatus are disclosed in one embodiment of the present invention as including a clamp suitable for engaging on, over, or otherwise securing to a visor built in to a vehicle. The clamp is in turn, secured to an adapter that receives an extension or adjuster extending some distance, such as from about six to about twelve inches away from the clamp. A second adapter at the end of the extension or adjuster may connect to another adapter that then secures a visor or miniature visor to the extension.

In one currently contemplated embodiment, the panel that acts as the miniature visor may be formed of a flat, plain, bordered, corrugated, ribbed, framed, concave, or convex, thin, or thick material. It may be shaped in any suitable shape from a circle, to a square, another polygon, an ellipse, or an elongated rectangle of suitable size. Typically, the panel is sized to block light from an effective point source, such as the sun or a reflecting object that reflects the sun, from both eyes of the user. A size of from about two and a half to about five inches wide, and from about five inches to about nine inches long (horizontally) has been found suitable (7 cm to 13 cm×13 cm to 23 cm). In one currently contemplated embodiment, a size of about three inches (8 cm) wide and about seven inches (12 cm) long has proven to be quite effective. A size of two inches (5 cm) by six inches (15 cm) is adequate in many circumstances. One valuable feature of the adjuster or extension is to form it of what is referred to as “gooseneck tubing.” The extension or adjuster is best embodied in a material that can be bent (inelastically) in any direction, to hold its shape in such a position. By forming a panel in such a way that it is comparatively light, with respect to the ability or strength of the extension to hold the weight of the panel, easy adjustability and stability have been accomplished.

Gooseneck tubing is made of metal formed in a helical pattern. A continuous ribbon of metal bears a joint formed on each side thereof, each edge. Between adjacent edges, twist adjacent turns of the base metal material.

In alternative embodiments, a comparatively soft and malleable metal (that will not work harden with bending) may form a center core surrounded by a stabilizer. A stabilizer may be plastic, an elastomeric material, a coating, or the like that will provide easy manipulation, yet stabilize the core metal against kinks. A kink may be thought of as a very sharp angle that may be permanent (effectively work hardened) or simply yielded (elastic failure or plastic failure). Such a failure of a material can make difficult the necessary re-straightening.

By surrounding the core metal with a comparatively thick cover, sharp bends may be prohibited. This assists in resisting work hardening and yielding and consequent premature, catastrophic failure (breakage) of the metal. This a conservation-of-mass principle at work. The presence of the cover limits how sharp a bend may be made in the base metal by obstructing its space defining an inside radius of a bend with a substantially incompressible mass.

In other embodiments, a solid, malleable, soft metal may serve as the extension or adjuster. Various composite materials, such as a comparatively malleable metal, having a core in a tubular cross section, where the core is a comparatively flexible polymeric material to prevent buckling, may provide additional stiffness by a tubular construction.

The panel may be formed of a suitable material, from wood, plastic, paper, any paper products such as a cardboard, or corrugated paper board, to plastic sheet stock, polymeric corrugated board, or the like. Metals may operate effectively, but may increase weight. Similarly, certain films may be formed in thicknesses or shapes (section modulus) effective to maintain their dimensional stability and provide comparatively light weight. The panel may also be formed to have certain degree of curvature in order to stiffen and stabilize its shape.

Clamps may be of any suitable type. For example, metal clips, clothes pin-type clamps, conventional metal clips or clamps, such as those used for clipboards and for clipping together large stacks of papers, metal springs on polymer bases, spring steel strap, or the like may be used. Certain plastic clamps, having either spring-loaded bands or coil springs, and the like may also be used.

Numerous mechanisms are available for fastening, binding, or otherwise securing the panel to an adapter at one end of the extension. The adapter at the clamp end of the extension may be implemented any of various ways.

In use, a clamp of an apparatus in accordance with the invention may be clipped to any edge of a visor of a vehicle. It may be adjusted by simply bending the extension or adjuster by hand. The extension may be bent directly, by grasping and manipulating it, or simply in response to a user (driver) grasping the panel. The extension simply follows placing the panel at a desired position. The adjuster or extension thereby simply conforms to whatever shape is required in order to maintain the panel at the desired location.

By virtue of the clamp being effectively compatible to provide securement to any location about the perimeter of the vehicle visor, a wide range of positioning is available. Its associated panel may position far rearward of a visor that is turned to cover or extend long a side window. Similarly, a visor in a down (deployed) position, or in an up (un-deployed, non-deployed, stowed) position may receive a clamp. One may thereby position a panel in any suitable location radially away from the visor.

By the same token, the visor in a non-deployed position may also receive an apparatus in accordance with the invention, thereby providing a wide range of positions of the panel with respect thereto. For example, the clamp may be placed on any edge, and the panel may be positioned therealong, or positioned far away from that edge. A driver may thus quickly grasp or grip the panel, and position it where desired.

If larger changes of position are required, the entire apparatus can be moved, released from the grip, the clamp, or both. The miniature shield, shade, mini-visor apparatus may be removed from the visor of the vehicle and repositioned within a range permitting a user to move the panel into the line of sight to be occluded. This eliminates the overly bright, point source of light from the field of view of a driver.

An apparatus may operate to provide a limited obstruction of a driver's view. It may be effective to block safely a point source of light. The apparatus may include a securement sized and shaped to readily, selectively, and without tools, attach to and dis-attach from an edge of a visor of a vehicle.

A panel extending in two dimensions may extend in at least one of the dimensions a distance effective to subtend a source angle. A source angle is formed between the point source and the two eyes of the driver. A flexible, elongated, extension, may extend between the securement and the panel. It is effective to move inelastically in the two dimensions and a third dimension between a first position and a second position. It moves in response to a force on the extension from one of the panel and the hand of a driver.

A flexible, elongated, extension, extending between the securement and the panel may be effective to move inelastically in the two dimensions and a third dimension. Motion between a first position and a second position occurs in response to a force on the extension from one of the panel, moved by a driver and the hand of a driver. Typically, the area of the panel is an order of magnitude less than that of a corresponding vehicle visor. Limited obstruction may occupy an area outside and in addition to the visor in a deployed condition. Alternatively, it may occupy an area within that which would have been blocked by the undeployed visor had it been in the deployed position.

The securement is usually a clamp. It may have a rigid portion, a spring, and a pivot. Alternatively it may be formed of a flexible, elastic material formed to have a tongue and a guide, together forming a mouth therebetween sized to receive the visor.

The clamp is formed to exert a force on the visor selected to hold the clamp, the weight of the apparatus, and the dynamic load (forces due to rigid motion) of the apparatus on the visor, without moving with respect to the visor. The extension is best formed of gooseneck tubing having a central axis and a diameter at any point therealong. The gooseneck tubing is sufficiently flexible to deflect orthogonally to the central axis in response to a force applied. A deflection thereby imposed on the gooseneck tubing is at least partially inelastic and effective to remain in the second deflected or position after leaving a first position.

A method of limited obstruction of a driver's view is effective to remove safely from view a point source of light. A securement is sized and shaped to readily and selectively attach to and dis-attach from an edge of a visor of a vehicle, without tools. A panel extends in two dimensions, one of the dimensions being a distance effective to subtend (cover a chord of) a source angle formed between the point source and the eyes of the driver. A flexible, elongated, extension, extends between the securement and the panel and moves inelastically between a first position and a second position in response to a force on it from either the panel or a hand of a driver.

One may attach the securement to a visor of a vehicle arbitrarily, near a path of light from a point source. The panel rests at a location between the eyes of the driver and the point source. Attaching the securement to the vehicle's visor may occur with the visor in an undeployed (up) position.

The chord length and panel length extend in a substantially or nominally horizontal direction. The width extends in a nominally or substantially vertical direction. The point source is not actually a point. It may define and subtend an “ocular angle.” This angle is formed between the image thereof on a retina of the driver (acting as the vertex) and the two ends of a horizontal, effective diameter of the “point source.” In other words, a point is infinitesimally small, but physical objects have a finite size.

Operating the vehicle with the panel occupying a substantially permanent position in a vehicle is possible over a distance of travel. Re-positioning the panel with respect to the securement is simple, when necessary, without moving the securement. The extension simply moves where necessary between the securement and the panel. One simply grips the panel and moves it.

A greater or different region of use for the panel is available by re-positioning the securement from a first visor location elsewhere on the visor. Thereafter, one may re-position the panel with respect to the securement to obscure the point source.

The visor has a first area constituting a greater obstruction of vision of the driver by the visor when in a deployed position. The panel has a second area constituting a lesser obstruction of vision of the driver by the panel. The second area is typically an order of magnitude less than the first area.

One method of limiting obstruction of a driver's view is still effective to remove safely a point source of light. By providing a securement sized and shaped to temporarily fix to an edge of a visor of a vehicle, one may support a panel sized to subtend a source angle formed between the point source as a vertex and the two eyes of the driver defining legs of the angle. An extension is formed to be flexible, elongated, and inelastically deflectable, between the securement and the panel.

Attaching the securement to a visor of a vehicle arbitrarily, the driver positions it near (with the panel within reach of) a path of light from a point source. The panel should cover the path (subtend; cover a chord) between the eyes of the driver and the point source. The visor may be fixed in either a minimum obstruction, stowed, position, a maximum obstruction, deployed position, or therebetween. The securement is sized and shaped to secure to the visor in any of those positions.

The panel length extends nominally, or even substantially, horizontally. The width extends nominally, or even substantially, vertically. The length should subtend a source angle formed between the point source (as a vertex of the angle) and the eyes of the driver, defining legs of the angle.

A “point source” is not a point. It subtends (chords) an ocular angle. This ocular angle is formed between the image of the point source on a retina of the driver (as a vertex) while effective diameter of the “point source” as legs of the angle define an arc length occupied by the point source within the field of view of the driver.

The length of the panel is best when slightly greater than either the chord or arc of the ocular angle and greater than either the chord or arc of the source angle. Often it is occupying a substantially permanent position over a significant distance of travel. One may often re-position the panel with respect to the securement without moving the securement. However, re-positioning the securement from a first visor location on the visor to a second visor location is simple with a single hand. One may do so before re-positioning the panel with respect to the securement to obscure the point source.

The visor has a first area constituting a comparatively large obstruction of vision when in a deployed position. The panel of the apparatus in accordance with the invention has a comparatively much smaller area constituting obstruction of vision of the driver, an order of magnitude less than that of the visor.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a perspective view of an interior of a cab of a vehicle illustrating an apparatus in accordance with the invention in use, secured to a free edge near a free end of a driver-side visor deployed in a vehicle;

FIG. 2 is a perspective view of one embodiment of an apparatus in accordance with the invention with the inelastically bendable, gooseneck extension in a completely straight arrangement;

FIG. 3 is a front elevation view thereof;

FIG. 4 is a rear elevation view thereof;

FIG. 5 is a left end elevation view thereof;

FIG. 6 is a right end elevation view thereof;

FIG. 7 is a top plan view thereof;

FIG. 8 is a bottom plan view thereof;

FIG. 9 is a perspective view of the apparatus in use on the driver side inside a vehicle, with the apparatus secured to a free end of a deployed, driver-side visor;

FIG. 10 is a perspective view from inside a vehicle with the apparatus secured to a free end of a passenger-side visor;

FIG. 11 is a perspective view inside a vehicle with the apparatus secured to a free edge near a free end of a deployed, passenger-side visor;

FIG. 12 is a perspective view of a driver-side position inside a cab of a vehicle, with the apparatus secured to a pivot edge of an undeployed, driver-side visor near the free end thereof;

FIG. 13 is a perspective view inside a cab illustrating the apparatus secured to a pivot edge of an undeployed, passenger-side visor, proximate a free end of the visor;

FIG. 14 is a perspective view inside a cab of a vehicle with the apparatus secured to a pivot edge of an undeployed, driver-side visor, near the free end of the visor;

FIG. 15 is a perspective view inside a cab of a vehicle with the apparatus secured to a pivot edge of an undeployed, driver-side visor, proximate a pivot end of the visor, and extending toward the free end of the visor;

FIG. 16 is a perspective view inside a cab of a vehicle with the apparatus is secured to a pivot end of a driver-side visor in a stowed or undeployed position of the visor, such that a panel of the apparatus provides an obstruction of a point source of light through a side window; and

FIG. 17 is a perspective view of an apparatus in accordance with the invention, including exploded views of alternative components for alternative embodiments made by combinations of the constituent components of the apparatus.

### DETAILED DESCRIPTION OF THE PREFERRED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, as claimed, but is merely representative of various embodiments of systems and methods in accordance with the invention. The illustrated embodiments will be best understood by reference to the drawings, wherein like parts are designated by like numerals throughout.

The following definitions of terms are used to clarify. In general, Applicant is defining these terms in order to clarify that the meanings are exactly those of ordinary meaning to one of ordinary skill in the art. One of ordinary skill in the art herein is expected to be a technician, the ordinary mechanic as stated in the law. The ordinary mechanic is a technician who manufactures, installs, repairs, or the like mechanical devices, and knows the names for common mechanical parts. For example, axles, pivots, beams, bars, fingers, bases, and the like are terms used by the ordinary mechanic working with physical, mechanical devices.

Herein, the term “obstruction” simply means an object that interferes with a path. In this case, the path is the path of light, and the obstruction is blocking light from a source (reflected or originating) of light viewed by a driver. A driver is simply a person operating a motor vehicle. Block is a term of art meaning the same thing as obstruct. An obstruction effectively stops or modifies travel of a thing along a path.

The term “safely” means in a manner that does not increase the risk to the user. Thus, a trade off in driver vision and awareness exists between a visor versus an apparatus in accordance with the invention. Light may cause difficulty in vision during operation a vehicle.

For example, bright lights tend to force the human eye to adjust to that bright light, rendering objects that are less bright less visible. By the same token, large visors used in vehicles often obstruct large swaths of the field view of a user. Thus, the term “safely” is also used to characterize the concept of providing a limited obstruction of a driver's view that leaves more of the field of vision available, while still obstructing light that may interfere with the driver's vision.

A “point source” of light means a comparatively very small region of the field of view or field of vision of a user is occupied. No object is truly a point. A point is infinitesimally small. Point sources are objects sufficiently far way that they appear as mere points in one's field of view. The sun, the reflection of the sun from another vehicle, a windshield, a shiny object, a mirror, or some mirage in the air over a roadway may be considered a point source. In this context, some point sources may actually be line sources of comparatively narrow width, but of a more substantial length. However, in general, a point source may be treated as a point in that it occupies so little of the field of view that it may be blocked or its light may be blocked by simply placing a small obstruction between the eyes of a user and that “point source.”

A securement simply means a mechanism to firmly and reliably attach one object to another. Tools indicate conventional, mechanical tools used to operate on work pieces such as screws, bolts, and the like. Tools, typically leverage (literally) the strength of human hands to achieve higher levels of force and stress. Thus, fingers of a user cannot grip a screw and remove it from a piece of wood or a bolt from a tightened nut. Thus, “tools” is used in its conventional sense. Hand operable fasteners are very different from tool-secured fasteners.

The term edge means exactly that. For example, any planar object has at least two surfaces, and each of those surfaces meet at an edge. An edge is typically at the outer extent of a surface.

A panel is simply a material or object that extends principally in two dimensions, with the third dimension being comparatively very small. That is, an aspect ratio of width to thickness or of length to thickness is large, like one or two orders of magnitude. Aspect ratio is a term used to define a ratio between one dimension and another, typically for a single object. Thus, an aspect ratio of one to one means that, for example, a width and a height are substantially equal. An aspect ratio of one hundred indicates that one dimension is a hundred times another. Thus, an aspect ratio of one to one would comport with a square or a circle. An aspect ratio of one hundred to one would comport with a long, skinny, even stranded object. Meanwhile, since all physical objects have three dimensions, aspect ratios may be defined between any two of those dimensions.

Vertical as used herein means nominally vertical. For example, a windshield of a car typically extends horizontally and vertically. Nevertheless, a windshield does not extend exactly vertically nor exactly horizontally. However, its dimensions do extend horizontally and vertically as well as in a third dimension transverse or orthogonal to both the vertical and horizontal directions.

“Subtend” is a term of art for geometry, often used in mechanical technologies or optics. It is typically used in engineering to define for technicians certain geometric relationships. Subtending refers to the fact that a particular dimension is as long as a chord across an arc.

For example, an angle is constituted by a vertex representing a point, and two legs extending from that point. The angle is the number of degrees or radians (or other measure) spanned by the legs of that angle. However, the legs typically are treated as being the same length. An arc may be scribed between those legs. That arc may be divided into degrees or radians representing the angle formed by the vertex and those two legs.

However, a chord extends directly from one end of that arc on one leg of the angle to the other end of that arc on the other leg of that angle. The chord cannot be subdivided into measurements or increments of angle conveniently according to geometric theory. Nevertheless, the chord subtends the angle in that it extends from one leg to the other leg of that entire angle.

Flexible is used as ordinarily applied to objects that may be deflected or bent (moved one portion with respect to another portion thereof) with comparative ease. Thus, as a comparative term, flexible depends very much on the forces at work. Flexible tends to mean also that a material will recover back to its original position after movement, or can easily be moved back.

Materials that are flexible and elastic will return to their original position when the force that deflects them is removed. In contrast, inelastic materials are those that deflect in response to force, and do not recover their original position when the force is removed. This also helps define “elastic” and “inelastic” as terms of art.

Elasticity is the ability to return automatically to an original position when a force is removed following deflection in response to that force. Inelasticity is an inability to return automatically to a starting position when a force is removed following deflection in response to that force. Some materials have both an elastic component of deflection and an inelastic component. This means that they may recover somewhat by moving from a second (forced, loaded) position back toward a first (unloaded, unforced) position, and yet not fully recover.

Rigid means exactly what is meant in the engineering arts and the associated technical mechanics thereof. Rigid indicates that every portion of a body moves in the same relative position with respect to all other portions of the body. Thus, rigid-body motion is often used to describe movement of an object that may rotate (pivot, spin, etc.) or translate (move along a line or along multiple lines each in a single dimension). The relative positions of every portion of that object remain the same with respect to each other regardless of movement of the object as a whole.

Often, a center of mass or center of gravity is defined to identify some central location on the object. That center may be tracked in the three possible dimensions of rotation and three dimensions of translation.

A pivot is a pivot, meaning generally that it may turn about a point. Pivot and rotate are similar terms. Often the term pivot is used to indicate that an object cannot spin a full three hundred sixty degrees, but the term is not so limited. Meanwhile, rotation need not mean that an object does spin more than three hundred sixty degrees, but is often used in that context. Thus, context will indicate whether an object needs to pivot less than three hundred sixty degrees, or whether it needs to rotate more than three hundred sixty degrees. It simply moves through an arcuate motion about a point.

Distance, length, area, width, thickness, and the like are used in their ordinary meanings. Typically, as pertains to a physical object, thickness is usually applied to the thinnest or the smallest value of physical dimension. Width is usually applied to the next larger value of a dimension orthogonal thereto. Length is usually applied to the greatest value of a dimension orthogonal to both.

A spring is an elastic member. That is, a spring is any material that behaves elastically. Springs may be formed of metals, plastic, elastomeric polymers, or the like. All solid materials have some degree of elasticity to them. Even solid steel blocks have a degree of elasticity, comparatively negligibly small when compared with that of an elastomeric “rubber band.” That band may extend hundreds of percent beyond its original dimension. In contrast, solid steel will move in tension on the order of millionths of its dimension or less.

A gooseneck is a term used to indicate a certain type of shape. Gooseneck tubing is a material that is sufficiently flexible that it may be bent, often in multiple places within a comparatively short distance (tens of diameters), and maintain that shape. Thus, a thin rod of spring steel would deflect and return to its original position. Gooseneck tubing moves, resisting that movement, yet holds its position inelastically once released.

An axis is a line and issued here in its ordinary meaning from mathematics, engineering, and technical fields.

Deflection simply means movement. Typically, deflection means that one portion of an object moves with respect to another portion of the object. Often, deflection is characterized as bending. Nevertheless, an object supported by some other object may be deflected, simply moving the original object by distorting the other object that supports or holds it. Nevertheless, in general, deflection is typically used to indicate a bending or movement of one portion of an object away from another portion of the object. It is often described in engineering terms as beam bending.

It is common in the mechanical arts to define mechanical objects in terms of bodily members. Thus, mechanical devices often are described to have a base, a foot, a leg, a body, an arm, a finger, a lip, a tongue, a tooth, a head, and so forth. Typically, these terms are used to represent a physical relationship similar to the bodily relationship. Thus, an arm will typically be of a substantially larger size than a finger. An arm will typically extend. A base or foot will typically be a supporting or anchoring member. Even an eye may be used to describe an aperture in an object. Thus, a tongue would typically be expected to extend away from some other portion of an object. A neck may represent a portion of an object comparatively narrower than some other greater portion surrounding it. A head will typically be a feature that has significance, such as a termination, a mounting location for some other object, or the like.

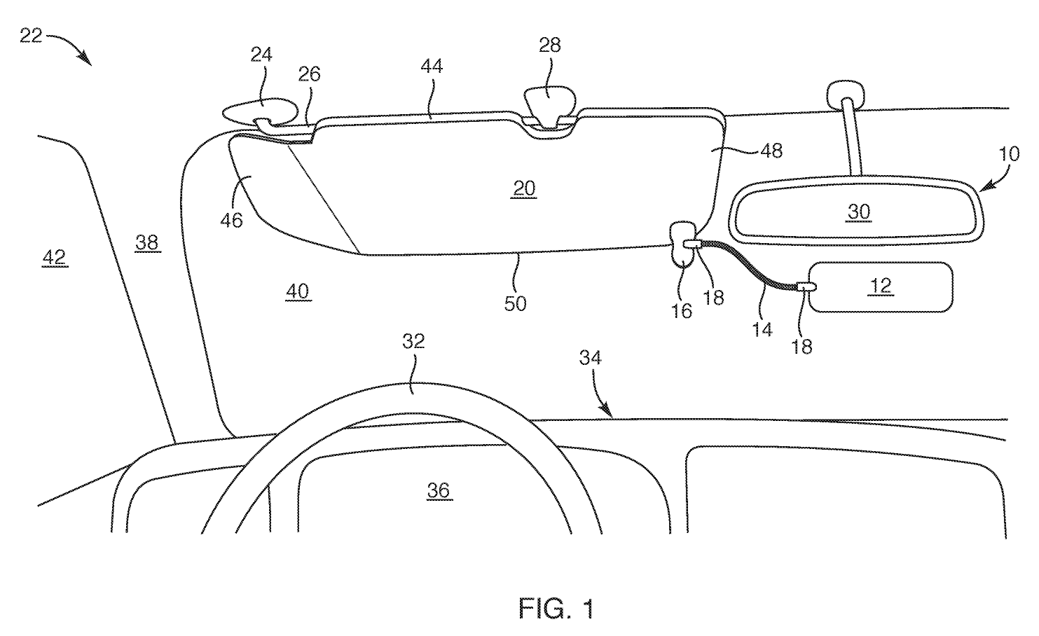

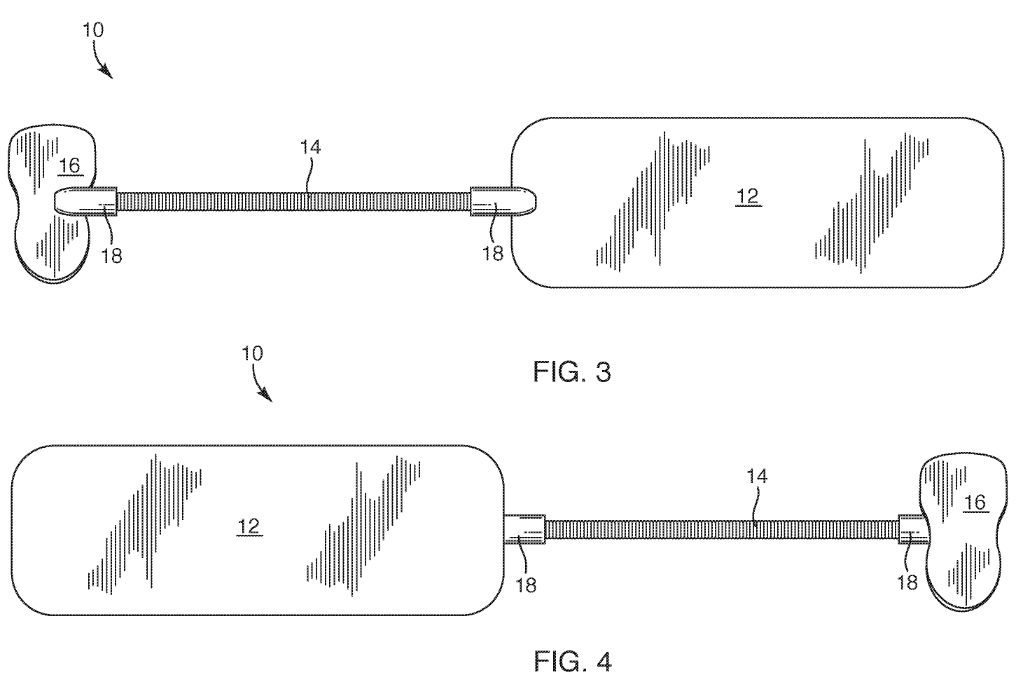

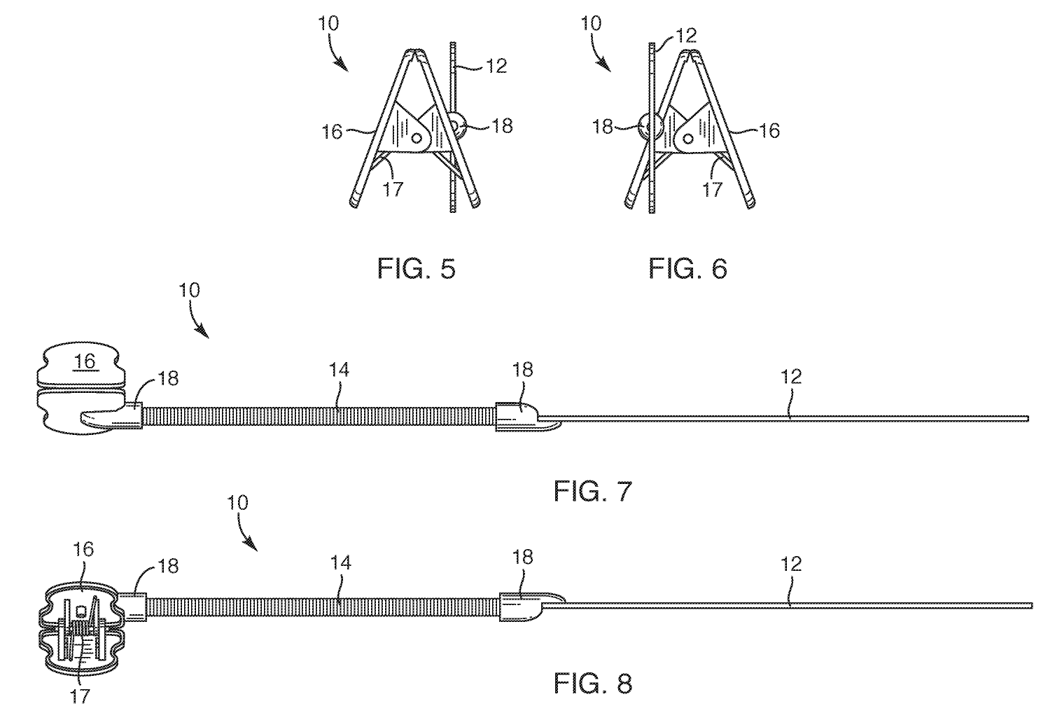

Referring to FIG. 1, while continuing to refer generally to FIGS. 1 through 17, an apparatus 10 or a system 10 in accordance with the invention may include several constituent components. These components may include, for example, a panel 12 for obstructing light. An adjuster 14 or extension 14 connects the panel 12, at one end of the extension 14, to a clamp 16 at the opposite end of the extension 14. The clamp 16 may be of any suitable type, and may include a separate spring 17 or not. At each end of the extension 14, an adapter 18 may secure the extension 14 to the panel 12 and the clamp 16, respectively.

As illustrated, the visor 20 of a vehicle 22 may receive a clamp 16 secured thereto. The visor 20 may be in the stowed position or the deployed position. For example, the illustrated embodiment of FIG. 1 illustrates the visor 20 in a deployed position, wherein the mount 24 or base 24 of the visor 20 supports a rod 26 operating as an axle 26 (a pivot 26) for the visor 20. When a visor 20 is particularly long or comparatively long extending away from base 24, a support 28 at an end or intermediate the ends of the visor 20 may capture the axle 26 or rod 26, to support it more firmly.

Typically, a vehicle will have a mirror 30, commonly referred to as a rearview mirror 30. A mirror 30 will typically be located near the center of the vehicle 22, while the steering wheel 32 (or simply the wheel 32 for steering) is positioned on the driver's side of the vehicle 22. The wheel 32 is typically secured to a column extending below a dash 34 or dashboard 34 containing gauges 36, instruments 36, or other controls 36.

Typically, a pillar 38 will act as a structural member 38 of the vehicle 22. That pillar 38 will typically be positioned between a windshield 40 and a window 42, or between windows 42. Pillars 38 may be positioned between various different adjacent windows 42 in the vehicle 22.

The mount 24 or base 24 of a visor 20 will typically be positioned near the pillar 38 on a driver's side, and a corresponding pillar 38 on a passenger's side of the vehicle 22. One may speak of a pivot edge 44 of the visor 20 as the edge 44 of the visor 20 that pivots about the axle 26 or rod 26. One may also speak of a base end 46 of the visor 20 as that end 46 closest to or proximate the base 24. By the same token, a free end 48 of the visor 20 is positioned away to the maximum distance that the visor 20 extends away from the base 24 or mount 24. This leaves a free edge 50 of the visor 20 opposite the pivot edge 44.

Typically, a rod 26 or axle 26 is provided with a bend into a vertical portion that will pivot in a horizontal plane about the base 24. Meanwhile, the visor 20 will typically pivot about a horizontal axle 26 as the horizontal axis 26 of rotation.

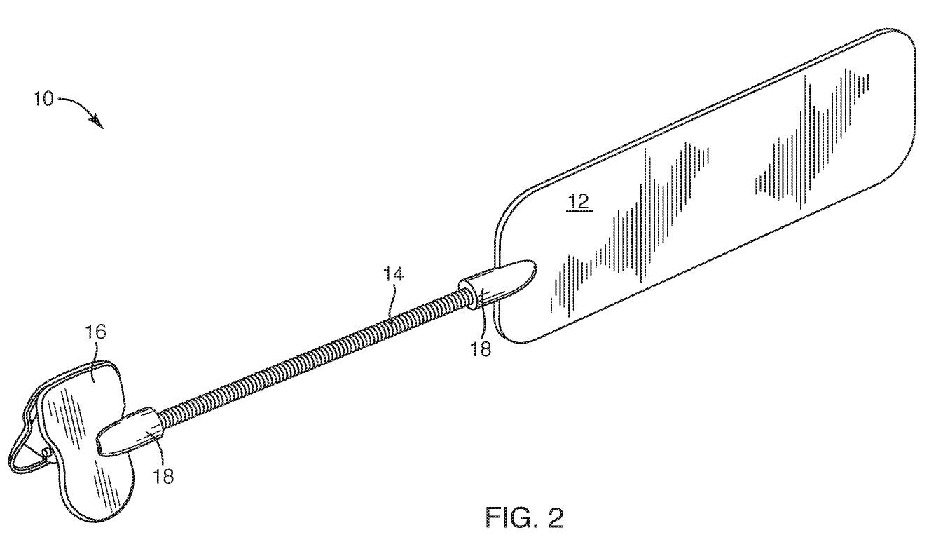

Referring to FIGS. 2 through 8, different views of the apparatus 10 or system 10 in accordance with the invention are illustrated. The extension 14 operates as an adjuster 14 in a rather rare position, being straight. Typically, one value of the extension 14 is its function as an adjuster 14.

For example, the extension 14 may typically be formed as a flexible and fixable arm 14. It extends between a clamp 16 secured to a visor 20 and a panel 12 for obscuring light. The panel 12 is spaced some distance away from the clamp 16 at any desired angle and total orientation. It moves in three dimensions to a location suitable for obstructing light from a point source from passing to the eyes of a driver of the vehicle 22. Each of the constituent components 12-18 of the apparatus 10 are illustrated in these figures.

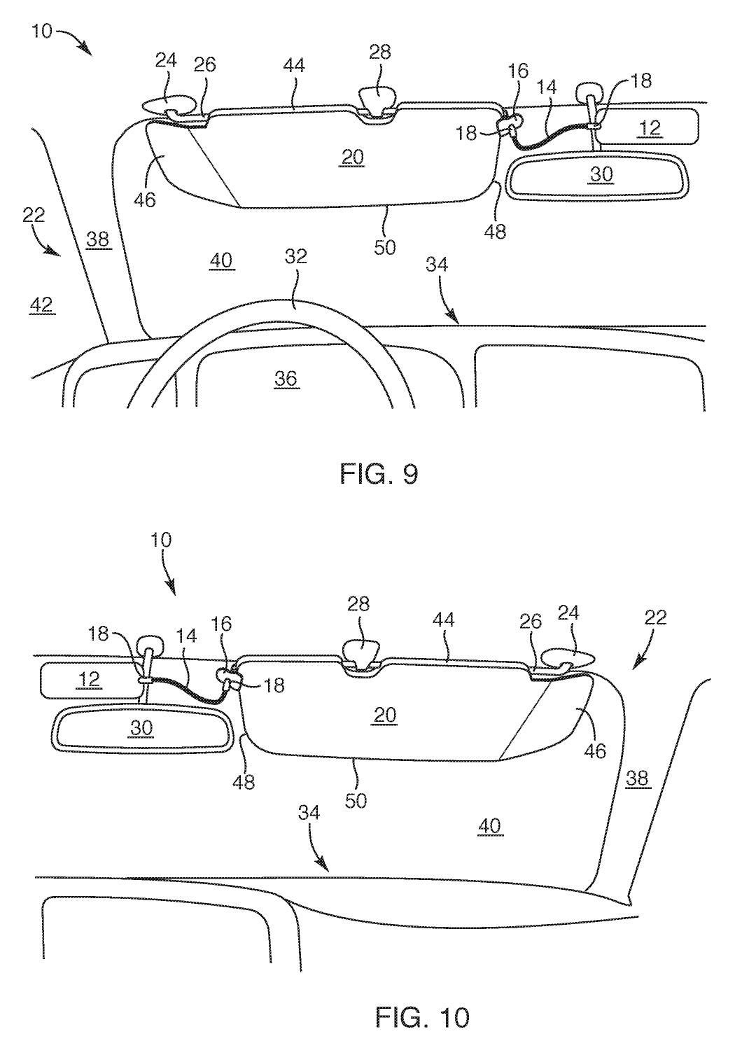

Referring to FIGS. 9 through 16, while continuing to refer generally to FIGS. 1 through 17, one will note that the clamp 16 may be designed and employed to secure to any particular edge 44, 46, 48, of the visor 20. Moreover, the clamp 16 may typically connect in any suitable orientation, consistent with its location on the visor 20 and the desired location for the panel 12. One particularly valuable aspect of the clamp 16 that may be considered in designing or selecting a clamp 16 for inclusion as a constituent 16 of the apparatus 10 is that the visor 20 need not be in any particular orientation or disposition. By disposition is meant the position of a visor 20 for use or nonuse.

For example, a visor 20 will typically pivot with respect to the base 24 in order to provide obstruction of light through either a windshield 40 or a window 42 adjacent thereto. Moreover, in some embodiments, a visor 20 may extend or slide along the axle 26 in order to be positioned farther away from the base 24 along the window 42, or farther from the base 24 along the windshield 40.

Referring to FIG. 9, the visor 20 is in a deployed position, having been pivoted about the axle 26 or rod 26 from a stowed (undeployed) position up near the ceiling of the vehicle 22, down to a deployed position obstructing a portion of the windshield 40. One will note that the clamp 16 is secured to the free end 48 of the visor 20. In this configuration, the extension 14 is bent or otherwise adjusted to place the panel 12 of the apparatus 10 in the area of the windshield 40 between visors 20, and above the rearview mirror 30.

Referring to FIG. 10, a configuration is illustrated in which the clamp 16 is secured to a free end 48 of a visor 20 on a passenger's side of the vehicle 22. Thus, the deployed position of the visor 20 having pivoted about the axle 26, provides obstruction of the light, such as from the sky or distant road, from a passenger. The apparatus 10 operates to obstruct light for a driver in a region of the windshield 40 near the rearview mirror 30, and not covered by either visor 20.

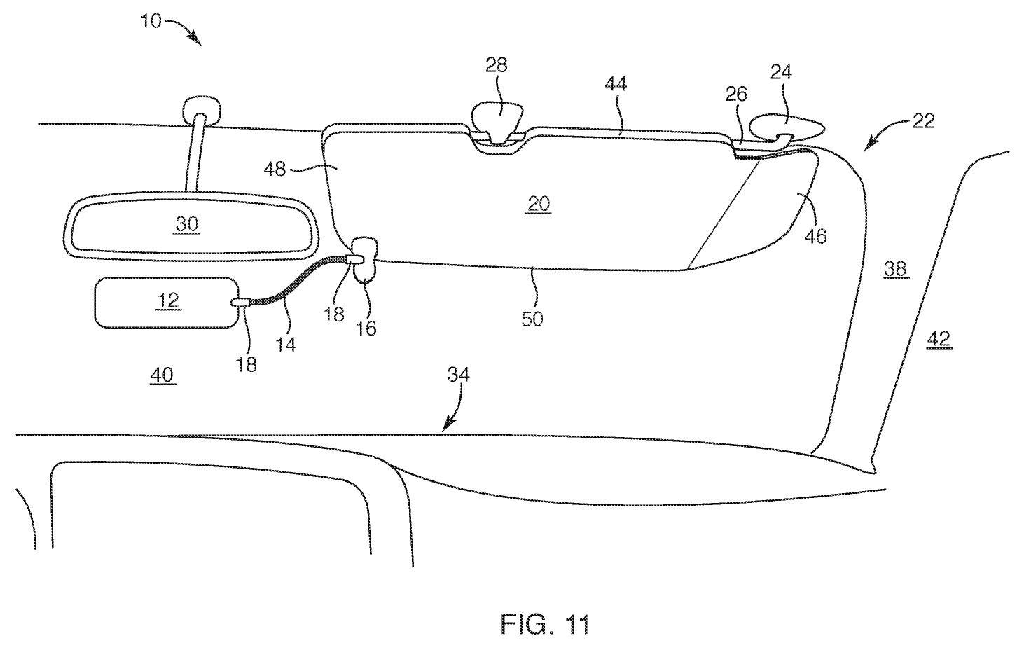

Referring to FIG. 11, the clamp 16 is secured near the free end, and along the free edge of a visor 20 on a passenger's side. The gooseneck 14 or extension 14 curves in multiple locations to position the panel 12 under the rearview mirror 30. This will obstruct a low (e.g., almost horizon level) light source from the eyes of a driver on an opposite side of the vehicle 22 from the passenger.

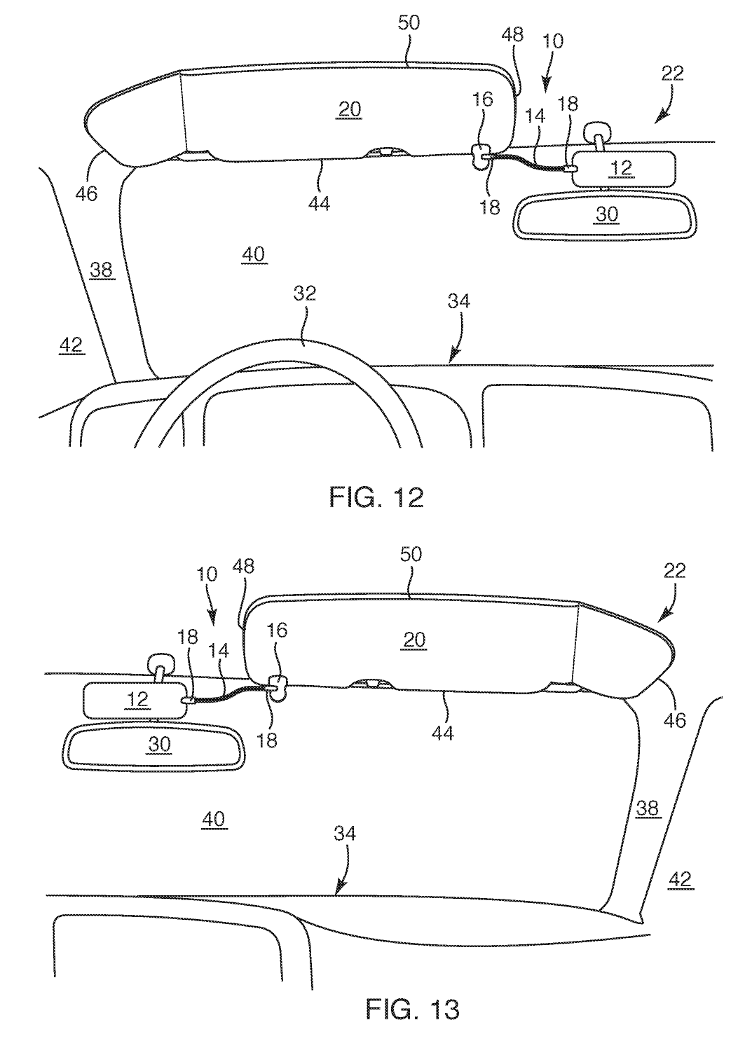

Referring to FIG. 12, the clamp 16 is secured to the pivot edge of an undeployed visor 20 on a driver's side of a vehicle 22. In this configuration, the panel 12 is positioned by the extension 14 bending at multiple locations in order to follow the positioning of the panel 12. In this configuration, the visor 20 is undeployed or stowed against the ceiling of the vehicle 22, and the panel 12 operates as the only “visor” 12 for the driver.

Referring to FIG. 13, the passenger-side visor 20 may receive a clamp 16 on the pivot edge of the visor 20 in order that the extension 14 may bend and extend to an area near the rearview mirror 30 placing the panel 12 in that un-visored region of the windshield 40 between the passenger and driver visors 20.

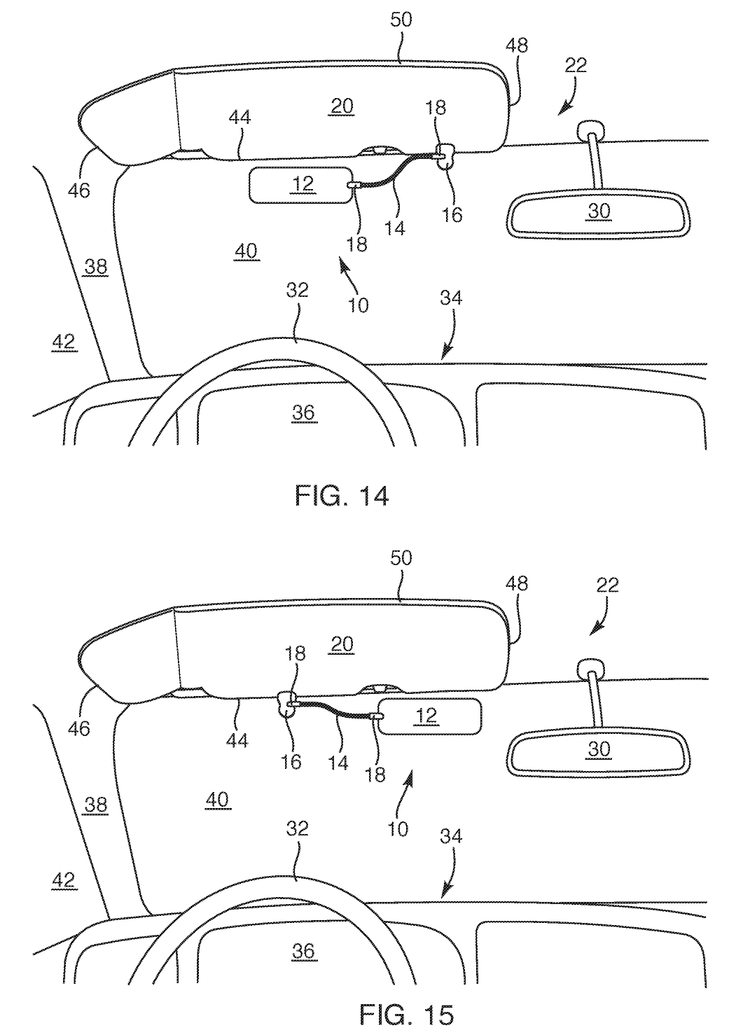

Referring to FIG. 14, one configuration with the panel 12 replacing the visor 20, relies on a clamp 16 connected to a pivot edge 44 of a driver's side visor 20 near the free end 48 of that visor 20. In this configuration, the driver's view is less obstructed than with the use of the visor 20 in a deployed position. By leaving the visor 20 stowed or undeployed, all the edges 44, 46, 48, 50 of the visor 20 remain available for securing thereto the apparatus 10.

Operating the clamp 16 to open and close it will connect it to the visor 20 at any suitable location. Here, the apparatus 10 is deployed, yet the visor 20 is not. The clamp 16 secures to the pivot edge 44 of the visor 20, and the panel 12 is positioned at the location where light obstruction is desired by the driver. Note that the panel 12 may be twisted or pivoted, or translated along a direction in any of three dimensions, by virtue of the multidimensional deflection possible for the extension 14.

In this embodiment, the panel 12 is basically rectangular in shape, but having slightly rounded corners. The panel 12 will typically be positioned in a horizontal orientation, the length extending horizontally. The maximum dimension may be thought of as the length, and it will typically extend in a horizontal direction. One reason for this is that the purpose of the panel 12 is to obstruct the approximately (slightly more than) the subtended angle of light rays (legs of angle) from an originating source (vertex of angle), and a user's eyes (at end of legs of angle; apart by distance subtended).

Since users' eyes are spaced some distance apart, then that entire subtended angle between the point source of light, and both eyes should be effectively obscured by the panel 12. This is much less than the distance spanned by a vehicle visor. Also, multiple shapes may be used, and different shapes may be used. However, this subtended angle is significant in the effective operation of the apparatus 10. Both eyes are shielded from the source of light, and remain so for a distance of travel, because the distant source does not move far nor quickly in the driver's field of view (maximum ocular angle spanned by horizon).

Referring to FIG. 15, this configuration of the apparatus 10 is similar to that of FIG. 14. However, in this configuration, the clamp 16, is secured elsewhere along the pivot edge. One may note that the adapters 18 fix the opposite ends of the extension 14 to the clamp 16 and the panel 12, respectively. Various embodiments of the adapters 18 will be discussed hereinbelow. Adapters 18 may be secured to the clamp 16 and the panel 12, or may be built into the panel 12, the clamp 16, or both 12, 16 during manufacture. Various purposes, considerations, and rationales exist for the various alternatives.

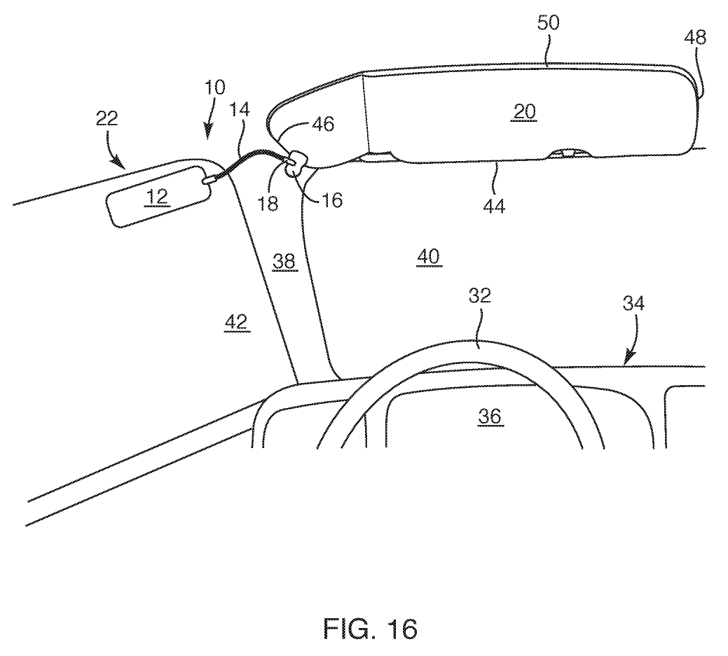

Referring to FIG. 16, the panel 12 may provide obstruction of the light coming through a window 42 adjacent a windshield 40. In the illustrated embodiment, the clamp 16 is secured to a free end 48 of the visor 20. The extension 14 extends and bends to orient the panel 12 at the desired location within the driver's field of view through the window 42. At this point, one should note that various permutations and combinations of rotation about a vertical axis (about the mount 24, by the rod 26) may position the visor 20 in front of the windshield 40, or in front of the window 42.

Similarly, the horizontal axle 26 or horizontal expanse of the rod 26 may also provide horizontal positioning. The free edge 50 of the visor 20 may take any position between the obscuration of the windshield 40, or the obscuration of the window 42. The visor 20 may be pivoted about a vertical axis of the mount 24. It may pivot simultaneously about a horizontal axis 26, the rod 26, between the windshield 40 and the window 42. The clamp 16 may be secured at any location therein.

Thus, just as the various configurations of the visor 20 and apparatus 10 may provide obstruction of a point source of light through the windshield 40, the visor 20 and apparatus 10 may be used in combination to position the panel 12 over any location in the side window 42 accessible by the panel 12 by bending the extension 14, and securing the clamp 16 to a suitable location or edge 44, 46, 48, 50 of the visor 20 in its location.

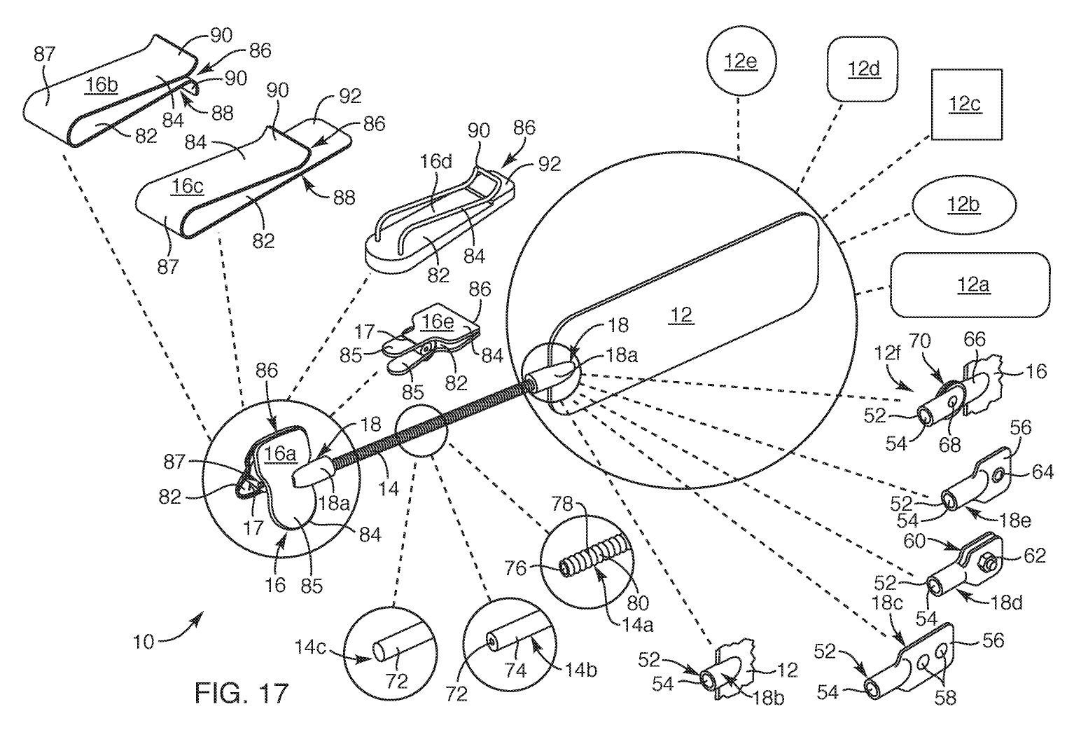

Referring to FIG. 17, a perspective view of one embodiment of a system 10 in accordance with the invention is illustrated. However, by exploded views of insets from that apparatus 10, various components 12, 14, 16, 18 are illustrated in alternative embodiments.

In the illustrated embodiment, a panel 12 secures to an extension 14 or adjuster 14 extending between the panel 12 and a clamp 16. Adapters 18 may be designed in any of several manners in order to mechanically support the forces exerted by the extension 14 on the panel 12 and the clamp 16, and vice versa.

For example, in one currently contemplated embodiment, a panel 12 may be substantially rectangular in shape. It may be comparatively thin on the order of between less than 1/32 inch (one millimeter) and perhaps up to ⅛ inch (three millimeters), depending upon the material. For example, a panel 12 may be formed of a comparatively stiff yet flexible polyethylene, polypropylene, polyethylene terephthalate (commonly known by the trademark of Mylar™), or the like.

In some embodiments, an expanded styrene (styrofoam), expanded polyethylene, corrugated cardboard, corrugated plastic, paper, cardstock, or the like may be used. For example, in various embodiments, the panel 12 may be substantially disposable. In other embodiments, the panel 12 may be highly reusable and structurally robust.

Several beneficial characteristics of the panel 12 may include, for example, a size (value) in length (nominally horizontal) that is typically about as long as the eyes of a user are wide. The technical expression is that the panel 12 should “subtend” or cover across the angle formed between the two eyes of a user and a point source of light on an opposite side (face) of the panel 12. The effect is that the point source of light is to be blocked from each eye and both eyes. In order for this to occur, the panel 12 should subtend the angle formed at a vertex located at the point source of light, and including legs of the angle directed to each eye of the user.

Thus, the length of the panel 12 is typically at least about the horizontal distance required to cover from the pupil of one eye to the pupil of the other eye, including both of the pupil diameters. Slightly longer length may serve better. Theoretically this length need not always be the width of the eyes, because that subtended angle will be subtended by a chord slightly narrower than the eye width. Nevertheless, as a practical matter, one may think of the length of the panel 12 being enough to fully cover both eyes of the user with extra margin.

As to the height (vertical, narrower, planar) dimension, multiple objectives suggest a balance of interests. For example, the height in a vertical direction should be sufficiently high that a user may move the head and eyes some distance typical of a driving condition, without exposing the eyes to the distant point source of light. On the other hand, one benefit of the panel 12 is the ability to minimize the obstruction to vision other than the view of point source of light being obstructed.

Thus, a length of from about five to about nine inches has been found suitable, with a distance on the order of about seven to eight inches appearing to be optimal. On the other hand, heights on the order of two to five inches are possible, with about three inches seeming to be a good target height for design. Meanwhile, the panel 12 may be completely flat, may be concave or convex, or otherwise shaped in order to provide sufficient stiffness when considering the material of which the panel 12 itself is made.

In one currently contemplated embodiment, the rectangular shape (or any polygonal shape) of the panel 12 is modified slightly to include rounded corners of a suitable radius. Other shapes are likewise suitable. For example, the panel 12a represents the base design, but the elliptical shape of the panel 12b, or the more square panel 12c, may be preferable for some drivers. A more rounded shape of the panel 12d or a completely circular shape 12e may also be desirable in certain situations.

For example, a point source is not always, and may never be, a true point source. Because the source is distant, and a comparatively small portion in the field of view of a driver, one may discuss the source of light as effectively a “point source.” Nevertheless, the sun actually has a width, and itself subtends a source angle. That may be defined as the angle between the image of the sun on a single retina surface of the eye of a user as a vertex of an angle, and two rays passing from that retina location to either (each) side of the sun.

An angle between the eyes formed about a vertex at the sun or other point source is another angle to be considered, the angle to be subtended. In other words, a source angle is formed between an image of a source of light on the retina behind a pupil of an eye, an image on the retina through the pupil of the other eye, with a vertex at the point source of light. This is a source angle. The source angle is to be subtended by the length of the panel 12.

The ocular angle or the eye angle is the angle formed between one image on one retina through the pupil of one eye, as a vertex with the legs of the angle proceeding to the two sides of the finite width of the “point source” of light.

Since the sun is actually round, the panel 12e has certain appeal. By the same token, since driving usually means movement over some period of time while the point source of light remains substantially constant, the elliptical panel 12b has certain appeal. Meanwhile, inasmuch as some point sources may come from reflective surfaces, the shape of the panel 12a likewise has certain appeal in that it may actually maintain an obstruction to the point source of light for longer periods of time and require less adjustment.

Nevertheless, personal preference always plays a part in selection of a panel 12. Thus, the panels 12 may be formed to be selectively removed from the adapter 18 and replaced.

The adapter 18 may be embodied in various structural configurations. For example, the adapter 18a is formed as a separate object that may be glued or suitably secured to the panel 12. The adapter 18a is the embodiment shown in FIGS. 1 through 16. On the other hand, the adapter 18b may simply be formed integrally with the panel 12 by laminating, forming, molding, drilling, or otherwise creating a socket 52 defining an aperture 54 sized to receive and secure the extension 14.

Similarly, the adapter 18c is formed as a separate object in which the socket 52 and aperture 54 are again sized to fit and secure by friction, compression, interference fit, glue, welding, heat, shrinking, or other fastening techniques to the extension 14. In this embodiment, the socket 52 adapts or changes shape near its blind end opposite the open aperture 54, to become a flat 56. That flat 56 may be of any suitable dimension, and any suitable shape.

A pair of snaps 58, or a single snap 58 and a registration edge in the flat 56 may orient the panel 12 with respect to the adapter 18c. The bearing length or distance between the centers of the snaps 58 may provide excellent stability.

A single snap 58 may need a rib or lip. The lip is a surface protruding toward the panel 12 and at right angles to the flat 56. By extending thereacross it may register a single snap system 58. It enforces the orientation of the panel 12 with respect to the extension 14.

In similar fashion, the adapter 18d may include a clevis 60 extending along both surfaces (opposite surfaces) of the panel 12. Here, some type of a fastener 62, may be a bolt and nut assembly 62, a rivet 62, or the like. Similarly, an adapter 18e may include the socket 52 as a collar 52 defining an aperture 54. Where the adapter 18e converts from the circular cross section of the socket 52 to a flat 56 to receive a rivet 64 or other fastener 64.

Rivets 64 may be formed of a plastic, metal, or any suitable material. Of course, fasteners 62, 64 may be constituted by glue, heat, welding, ultrasonic melting and bonding between the adapter 18 and the panel 12, or the like.

In one interesting embodiment, the adapter 18f may actually be constituted by a joint 70. In this embodiment, a securement 66 or grip portion 66 may be configured as in any of the adapters 18a, 18b, 18c, 18d, 18e, or the like, including similar or different attachment mechanisms 62, 64.

Meanwhile, an axle 68 or pivot 68 operates to form the joint 70 between the securement portion 66 and the socket 52. The socket 52 may rotate about the axle 68 or pivot 68 with respect to the securement 66. This provides an additional degree of freedom of the panel 12 to pivot with respect to the socket 52, and therefore with respect to the extension 14. Nevertheless, a rigid connection between the extension 14 and the panel 12 may be made by a solid, rather than pivoting, adapter 18.

The extension 14 may be configured in one of several embodiments. One currently contemplated embodiment includes a core 72 or solid metal 72 or other material 72 that is quite malleable. Often this may be problematic. Nevertheless, certain metals exist that are comparatively easily bent inelastically, and may take on various shapes. Certain composite materials may include these properties.

For example, in one embodiment, the core 72 may actually be laminated layers of metal that resist by friction between the layers. They allow repeated bending, re-bending, and re-straightening, and so forth. Nevertheless, it has been found that typically a solid core 72 may be adequate to serve in the extension 14c. It may be best served by a surrounding layer 74 operating as a stabilizer 74. Stabilization occurs by virtue of the layer 74 or stabilizer 74 limiting the bend angle possible in the core 72. A particularly severe or sharp angle is limited by the amount of the coating 74 or layer 74 inside a corner. Operating as a stabilizer 74 it limits by the principle of “conservation of mass.” It defines exactly how much angle or what bend radius may be put into the core 72. For example, the GUMBY™ character is a “stick figure” of a malleable wire 72 embedded inside a much thicker rubber coating 74.

A gooseneck 80 or gooseneck tubing 80 may serve as an excellent extension 14. The expression “gooseneck tubing” refers to a specific manufacture of metal having a continuous, spiraling joint formed in a sheet metal. Sheet metal is formed in an interlocking spiral shape axially sliding engagement exists between adjacent, looping turns of material. Adjacent turns of a single strip are connected by an interlocking joint 78. In an axial direction, along the length of the gooseneck tubing 80, the joint 78 may permit sliding between adjacent portions (turns) of material. Nevertheless, this sliding is resisted. Thus, the gooseneck tubing 80 may be bent along some radius of curvature tolerated by compression between turns to a minimum width of the joint inside of the curve. Extension or expansion to a maximum degree (axial distance) of the joints 78 occurs on the opposite side (or outside) of the curve.

Gooseneck tubing 80 has been found to provide an excellent extension 14a. Thus, the embodiment of an extension 14a has been found to be suitable, and gooseneck tubing 80 may be formed in various diameters, of various materials, in order to serve mechanically. One benefit of comparatively larger diameters of gooseneck tubing 80 surrounding their hollow 76 or interior 76, is the increased section modulus (an engineering term of art well defined in the engineering art of structures, structural mechanics, and mechanics of materials). It is here in exactly that way. It defines stiffness and strength for the extension 14a.

A narrower diameter of the gooseneck tubing 80 may be on the order of about ⅛ of an inch (2 mm) and provides more ready bending, less stiffness, less force required to form the extension 14a, lighter weight, and a tighter (smaller) bend radius on any bend in the extension 14a. The spacing between the joints 78 and the diameter of the hollow 76 and the outside of the gooseneck tubing 80 operate similarly to the coating 74 to limit the bend radius on any bend of the extension 14a.

Various embodiments of a clamp 16 are represented by the clamps 16a, 16b, 16c, 16d, 16e. Throughout this document, a trailing alphabetical character following a numerical reference number indicates a specific embodiment or alternative to the item identified by the reference number. Thus, it is proper to speak of a clamp 16 representing any or every clamp, in context, or an individual clamp 16a, 16b, 16c, 16d, 16e representing their specific embodiment or instance. This is true of all trailing letters on reference numerals in all figures herein.

Many clamps 16 exist, of a type 16a built around pivoting sides, gripped to open a mouth 86. Typically, a clamp 16 will have a base 82 and a cantilever 84. Actually, in many embodiments, clamps 16 include a base 82 and a cantilever 84 identical to one another. In other embodiments, a clipboard or solid surface may form a base 82, while the only moveable element or the principal movable element is the cantilever 84. Accordingly, a pressure region 85 on the cantilever 84 is actuated by force applied thereto in order to open the mouth 86. Opening of the mouth 86 may be resisted by a spring 17 tending to force back ends of the base 82 and cantilever 84 apart.

Typically, some mechanisms such as a pivot, hinge 87, or the like may be formed between the base 82 and the cantilever 84. In reality, in many clamps 16, both the mouth 86 and the pressure region 85 are cantilevered about the hinge 87. Nevertheless, cantilevers 84 and hinges 87 may be configured in other ways.

For example, the clamp 16b may include a mouth 86 opening to provide a throat 88. The throat 88 may be thought of as the narrowest portion of the clamp 16b. It actually may include a closed position in which the throat 88 places the base 82 and the cantilever 84 into contact. Thus, in such an embodiment the closed end portion 87 or hinge 87 provides the deflection permitting the guides 90 or lips 70 to separate to open the mouth 86 to receive the visor 20.

Meanwhile, the adapter 18 or extension 14 may secure directly to the cantilever 84, or even, in some embodiments, to the base 82. However, in most embodiments, at least one of the cantilever 84 and the base 82 must move with respect to the other. In some events, the cantilever 84 may move away from the base 82, and away from the visor 20 captured by the base 82 or against the base 82.

For example, the mouth 86 may be opened by spreading the guides 90 away from one another, thus opening the mouth 86, and receiving the visor 20 therein. Typically, the hinge 87 or the spring 87 at the back of the clamp 16 will be sufficiently powerful or strong, to have sufficient mechanical stiffness to maintain the clamp 16b firmly on the visor 20. Thus, manipulation of the panel 12 and the extension 14 may occur without dislodging a clamp 16b from the visor 20.

The clamp 16c similarly includes a base 82 and cantilever 84 connected through the hinge 87 or spring 87. The hinges 87 in the embodiments of clamps 16b, 16c are solid metal, and do not actually represent a hinge. Nevertheless, they may be replaced with a hinge 87 and a spring 87. However, in the illustrated embodiments, the clamps 16b, 16c provide both hinging and force by mere deflection of the solid, metal hinge region 87 in response to force applied to separate the cantilever 84 from the base 82.

In the embodiment of a clamp 16c, the guide 90 is set back some distance away from an end of a tongue 92. Thus, when the mouth 86 is open, the tongue 92 is used as a place to apply force by and to a visor 20. A digit of a user may hold down the base 82, or hold in place a base 82, while lifting the guide 90 and the cantilever 84 therewith. Thus, one may place the tongue 92 on one face or surface of a visor 20 and lift the cantilever 84 away therefrom by means of the guide 90, and slide the clamp 16c against the visor 20 until the hinge portion 87 contacts in a suitable edge 44, 46, 48, 50 of the visor 20.

The clamp 16d operates similarly to the clamp 16c. However, the cantilever 84 may be formed as a wire 84, such as a spring wire. Just as the clamps 16b, 16c are formed of a spring material, either plastic or metal, and typically best served by spring steel, the wire cantilever 84 may be embedded in a base 82 of wood, plastic, or the like. Accordingly, the guide 90 is lifted away from the tongue 92 of the base 82 in order to open the mouth 86 for receiving the visor 20 just as the clamp 16c operates.

The clamp 16e is more conventional, in which a cylindrical spring 17 fits over both a base 82 and a cantilever 84. The cantilever 84 and base 82 may be symmetric or identical with pressure regions 85 on each and a mouth 86 in which the base 82 and cantilever 84 separate as they pivot about the spring 17. Thus, a mouth 86 opens between the cantilever 84 and the base 82, closing to bring together the pressure regions 85 of each 82, 84 thereon.

The present invention may be embodied in other specific forms without departing from its purposes, functions, structures, or operational characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. An apparatus, operating as a limited obstruction of a driver's view, effective to block safely a point source of light, the apparatus comprising:
a securement sized and shaped to readily, selectively, and without tools, attach to and dis-attach from an edge of a visor of a vehicle without tools;
a panel extending in two dimensions, including extending in at least one of the dimensions a distance effective to subtend a source angle formed between the point source and the eyes of the driver;
a flexible, elongated, extension, extending between the securement and the panel and effective to move inelastically in the two dimensions.

2. The apparatus of claim 1, wherein the extension is effective to move inelastically in a third dimension between a first position and a second position in response to a force on the extension from one of the panel and the hand of a driver.

3. The apparatus of claim 1, wherein the area of the panel is an order of magnitude less than a corresponding area of the visor.

4. The apparatus of claim 1, wherein the limited obstruction occupies an area outside and in addition to the visor in a deployed condition.

5. The apparatus of claim 1, wherein, when the visor is in an undeployed position, the limited obstruction occupies a second area replacing a portion of a first area normally blocked by the visor when the visor is in a deployed position.

6. The apparatus of claim 1, wherein the securement is a clamp.

7. The apparatus of claim 6, wherein the clamp comprises a rigid portion, a spring, and a pivot.

8. The apparatus of claim 6, wherein the clamp comprises a flexible, elastic material formed to have a tongue and a guide forming a mouth therebetween sized to receive the visor therebetween.

9. The apparatus of claim 6, wherein the clamp is formed to exert a force on the visor selected to hold the clamp, the weight of the apparatus, and the dynamic load of the apparatus on the visor, without moving with respect to the visor.

10. The apparatus of claim 1, wherein:
the extension is formed of gooseneck tubing having a central axis and a diameter at any point therealong;
the gooseneck tubing is flexible to deflect in a direction orthogonal to the central axis in response to a force applied thereto, the extension moving from proximate a first position to proximate a second position; and
a deflection thereby imposed on the gooseneck tubing is at least partially inelastic and effective to remain in the second position.

11. A method of limited obstruction of a driver's view, effective to remove safely a point source of light, the method comprising:
providing a securement sized and shaped to readily and selectively attach to and dis-attach from an edge of a visor of a vehicle without tools;
providing a panel extending in two dimensions, including extending in at least one of the dimensions a distance effective to approximate subtending a source angle formed between the point source and the eyes of the driver;
providing an extension selected to be flexible, elongated, and extending between the securement and the panel and effective to move inelastically between a first position and a second position in response to a force on the extension from one of the panel and the hand of a driver;
attaching the securement to a visor of a vehicle at a location thereon arbitrarily selected by the driver and proximate a path of light from a point source thereof;
fixing the panel between the eyes of the driver and the point source.

12. The method of claim 11 wherein attaching the securement occurs when the visor is in an undeployed position.

13. The method of claim 11, wherein the length extends in a substantially horizontal direction and the width extends in a substantially vertical direction.

14. The method of claim 12, wherein the point source subtends a portion of an ocular angle, formed between the image thereof on the retina of the driver and the ends of a horizontal effective diameter of the point source, less than the length of the panel.

15. The method of claim 11, comprising operating the vehicle with the panel occupying a substantially permanent position over a distance of travel.

16. The method of claim 15, comprising re-positioning the panel with respect to the securement without moving the securement.

17. The method of claim 15, comprising:
re-positioning the securement from a first visor location on the visor to a second visor location on the visor; and
re-positioning the panel with respect to the securement to obscure the point source.

18. The method of claim 15, wherein the length of the panel is selected to subtend the source angle during travel of the vehicle horizontally.

19. The method of claim 11, wherein:
the visor has a first area constituting obstruction of vision of the driver by the visor when in a deployed position;
the panel has a second area constituting obstruction of vision of the driver by the panel; and
the second area is an order of magnitude less than the first area.

20. A method of limited obstruction of a driver's view, effective to remove safely from view a point source of light, the method comprising:
providing a securement sized and shaped to temporarily fix to an edge of a visor of a vehicle, a panel sized to approximate subtending a source angle formed between the point source and the eyes of the driver; and an extension formed to be flexible, elongated, and deflectable inelastically in three dimensions, the extension extending between the securement and the panel;
attaching the securement to a visor of a vehicle at a location arbitrarily selected by the driver and proximate a path of light from the point source thereof;
positioning the panel between the eyes of the driver and the point source.
